(19) United States
(12) Patent Application Publication
(10) Pub. No.: US 2024/0360715 A1
(43) Pub. Date: Oct. 31, 2024

(54) DOOR SWITCH AND CENTERING TAB

(71) Applicant: Universe Machine Corporation, Edmonton (CA)

(72) Inventor: Kurt R. Feigel, Edmonton (CA)

(73) Assignee: Universe Machine Corporation, Edmonton (CA)

(21) Appl. No.: 18/636,804

(22) Filed: Apr. 16, 2024

(30) Foreign Application Priority Data
Apr. 30, 2023 (CA) 3198257

(51) Int. Cl. E05F 3/22; E05F 3/10

(52) U.S. Cl. CPC E05F 3/227; E05F 3/10; E05Y 2900/132

(57) ABSTRACT

A door switch is suitable for use with a power tong having a door mounted on a tong body to close a throat. The door switch includes a moveable component that is in operational contact with the door and a valve control. The moveable component is biased into contact with the door when the door is in a closed position. The biasing mechanism biases the moveable component to move axially when the door is at least partially open to cause a valve to disengage a hydraulic motor supply. The moveable component disengages from the door when the door is at least partially open. A tab for the power tong has a plurality of edges, each edge defining a smallest distance from a center of a through hole to the respective edge, and each of the smallest distances of each edge being different in size.

### TECHNICAL FIELD

Power tongs for well operations.

### BACKGROUND

Power tongs are an essential product used in the oil and gas industry for well drilling operations. However, power tongs pose a safety hazard to personnel near them. Power tongs include a rotating portion, namely, a ring gear assembly, that poses a pinching risk for operators. To reduce the risk to operators, tongs generally include a door that, when closed, removes a pinch point thereby increasing safety to the operators. Various switch devices have been created to prevent operation of the tong and rotation of the rotating portion when the door is in an open position. However, these devices have various drawbacks. Further, electronics and electronic switches cannot be used near the drilling well as they pose a fire hazard given the high-pressure oil flow at the well site. Therefore, only mechanical or hydraulic switches can be used near the drilling well.

Power tongs are used to bite and twist sections of piping or casing together. Power tongs apply substantial torque and force on the tubular during a bite. In order to ensure the bite does not damage the tubular or tong and achieves the highest torque available, the tubular should be correctly aligned within the teeth and jaws of the tong. The teeth and jaws are the components of the tong that grip the tubular. The teeth and jaws are contained within the ring gear assembly. Operators generally align the tubular by using their hands and eyes to hold the tong in the correct position around the tubular. Once the tubular is in the correct position, the operator causes the jaws and teeth to bite the tubular through various control means and hydraulics on the tong. The jaws then hold the tubular while the ring gear assembly rotates. If the operator does not correctly position the tubular within the jaws and teeth, the operator will need to release the tong from the tubular, re-align the tong, and re-bite the tubular. This process wastes time and puts the operator at risk by additional and unnecessary movement of the jaw components.

### SUMMARY

In one exemplary embodiment there is a door switch for a power tong. The power tong has a ring gear assembly having a throat, the ring gear assembly is driven by a motor having a hydraulic supply and a door pivotally mounted on a body to open and close the throat. The door switch may comprise: a sleeve defining a bore; a moveable component within the bore, the moveable component being in operational contact with the door and a valve control of a valve connected to the hydraulic supply. A biasing mechanism may be included to bias the moveable component into contact with the door when the door is in a closed position, and the biasing mechanism may bias the moveable component to move axially when the door is at least partially open to cause the valve to disengage the hydraulic supply from the motor and the moveable component to disengage from the door when the door is at least partially open.

In various embodiments, there may be included any one or more of the following features: the moveable component comprises a cable within the bore and the cable is configured to engage and disengage the hydraulic supply from the motor through axial movement of the cable within the bore; the moveable component further comprises a piston connected to the cable and the piston being configured to contact the door when in the closed position; the biasing mechanism comprises a spring configured to bias the piston against the door when the door is in the closed position; the door further comprises a block configured to contact the piston when the door is in the closed position; the block comprises a ramp and a divot, and the ramp and the divot are shaped to receive the piston; the door is pivotally mounted on a body on a first side of the throat and the moveable component is in operational contact with an end of the door opposite from the first pivot when the door is in the closed position; the throat comprises a radius, and wherein the piston is substantially axially aligned with a centerline of the radius or substantially perpendicular with the centerline; the door switch in operation on a power tong; the movable component runs partially along a side of the body; and wherein the door comprises a first door and a second door, and the sleeve is connected to the second door and the moveable component being in operational contact with the first door.

In another exemplary embodiment there is a power tong, comprising: a ring gear assembly having a throat, the ring gear assembly being driven by a motor having a hydraulic supply; a first door having a pivot end mounted on a first pivot on a body on a first side of the throat, and the first door having a distal end that opens and closes the throat with movement of the first door around the first pivot; and a door switch, comprising: a sleeve defining a sleeve bore and a cable axially moveable within the sleeve, the cable having a valve end and a door end, the valve end of the cable being in operational connected with a valve control operable to disconnect the hydraulic supply from the motor, and the switch end of the cable being configured to be in operational contact with the distal end of the door when the door is in a closed position.

In various embodiments, there may be included any one or more of the following features: a piston connected to the cable and the piston contacting the distal end of the first door when the first door is in a closed position; a biasing mechanism to bias the piston into contact with the distal end of the first door when the first door is in a closed position; the biasing mechanism comprises a spring; the first door further comprises a block at the distal end of the door configured to contact the piston when the door is in the closed position; and the block comprises a ramp and a divot, and the ramp and the divot are shaped to receive the piston; and a second door having a second pivot end mounted on a second pivot on the body on a second side of the throat, and the sleeve connected to the second door.

In another exemplary embodiment there is a tab for a power tong, the tab comprising a body having a perimeter and having a through hole extending through the body within the perimeter, the body made of a non-compressible material, the body having a plurality of edges on the perimeter, each of the plurality of edges defining a smallest distance from a center of the through hole to the respective edge, and each of the smallest distances of each of the plurality of edges being different in size.

In various embodiments, there may be included any one or more of the following features: an edge of the plurality of edges is curved to match a radius of a throat when placed in the power tong.

In another exemplary embodiment there is a method of centering a tubular within a power tong, the power tong having a ring gear assembly having a throat, the ring gear assembly including teeth to engage a tubular and the ring gear assembly including a fastener-receiving hole, the ring gear assembly being driven by a motor having a hydraulic supply and a first door pivotally mounted on a body to open and close the throat, the method comprising: aligning at least one of the plurality of edges of the tab to match a circumference defined by a closed position of the teeth; and securing the tab with a fastener through the through hole of the tab and the fastener-receiving hole.

In various embodiments, there may be included any one or more of the following features: loosening the fastener; rotating the tab to align a different one of the at least one of the plurality of edges with the circumference defined by the position of the teeth in the closed position; and tightening the fastener.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is an embodiment of a power tong in an isometric view.

FIG. 2 is a top view of the power tong of FIG. 1.

FIG. 3 a top view of the power tong of FIG. 1 with the door open.

FIG. 4 is a close-up top view of the door switch of the power tong of FIG. 1.

FIG. 5 is a close-up top view of the door end of the power tong of FIG. 1.

FIG. 6 is a close-up isometric view of the valve of power tong of FIG. 1.

FIG. 7 is an exploded view of an embodiment of a door switch.

FIG. 8 is an isometric view of an embodiment of a double-door power tong.

FIG. 9 is an isometric view of an embodiment of a compact power tong.

FIGS. 10 and 11 are isometric views of an embodiment of a door block.

FIG. 12 is a close-up view of an embodiment of a sleeve end.

FIG. 13 is a top view of an embodiment of a tab.

FIG. 14 is a side view of the embodiment of the tab of FIG. 13.

FIG. 15 is a top view of an embodiment of a power tong.

### DETAILED DESCRIPTION

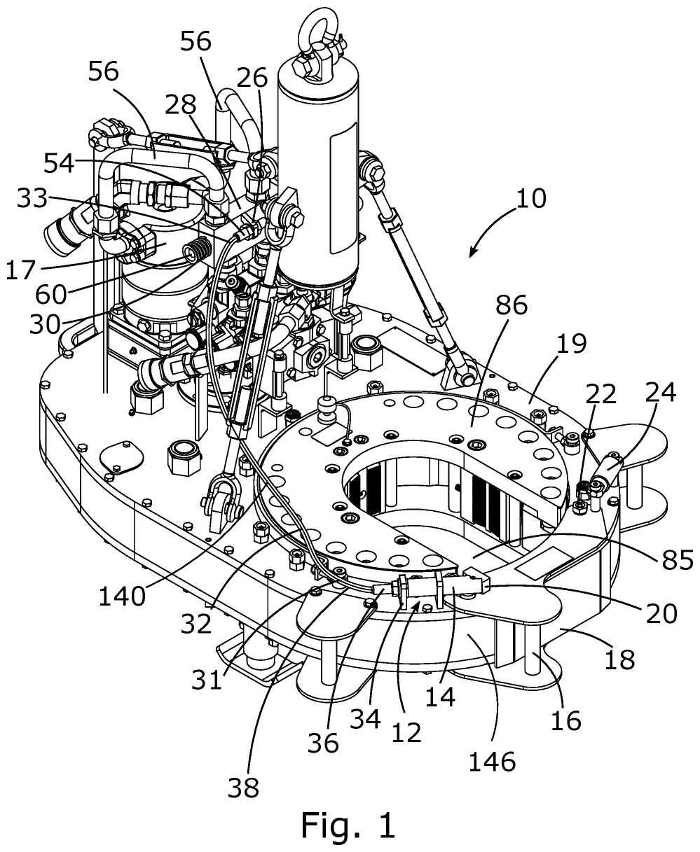

In an exemplary embodiment there is a door switch 12 for a power tong 10 as shown in FIG. 1. The door switch operates to automatically shut off the motor of the power tong when the door opens. The power tong 10 has a ring gear assembly 86 having a throat 85. The ring gear assembly 86 is driven by a motor 17 having a hydraulic supply and a door 18 pivotally mounted on a body 19 to open and close the throat 85. The door switch 12 may be installed on a power tong when it is manufactured or may be retrofitted onto an existing power tong. The door switch includes a sleeve 38 defining a bore. A moveable component 140 moves within the bore. The moveable component may be any moving component that operationally connects the door 18 to a valve control 60 of a valve 28 connected to the hydraulic supply.

Various different components can be used to form the moveable component. In some embodiments, the moveable component may include one or more of rollers, pistons, rods, cables, links and other components that provide a physical connection between the door 18 and the valve control 60. Each of these components may collectively define the moveable component. The use of a physical connection allows the movement of the door to turn on and off the hydraulic supply of the motor without requiring any electronics. The sleeve provides a conduit to direct and contain the movement of the moveable component. For example, when the moveable component is a cable, the sleeve will confine the movement of the cable so that it acts axially to open and close the valve control rather than merely bending. The sleeve may also include a housing to confine movement of a piston. The term sleeve is used to define a conduit through which the moveable component moves and it may not have a uniform diameter. The sleeve may include a sleeve containing a cable as well as a housing that houses a piston, with the cable sleeve and the housing have different internal diameters. Any mechanism may be used for the moveable component so long as it provides operational contact between the door and the valve control. For example, in some embodiments the moveable component may be a fluid that is contained in the sleeve that acts on pistons on both ends of the sleeve, in which the pistons convert the movement of the fluid into mechanical movement which can act on various other components such as rods.

In an exemplary embodiment, a biasing mechanism acts to bias the moveable component into contact with the door 18 when the door 18 is in a closed position. The biasing mechanism biases the moveable component so that it is pushed against the door. The biasing mechanism biases the moveable component to move axially when the door is at least partially open to cause the valve to disengage the hydraulic supply from the motor and the moveable component disengages from the door when the door is at least partially open. In some embodiments the biasing mechanism may be a spring, such as a coiled spring, but other springs and other types of biasing mechanisms may be used. For example, the biasing mechanism may be an elastic material, such as a rubber, shaped to apply axial force on the moveable component. The biasing mechanism may also be a pneumatic or hydraulic piston or other type of actuator. The biasing mechanism may also be a magnetic device. The biasing mechanism may be connected at any position within the door switch so long as the spring provides an axial bias on some part of the moveable component. The specific location of the biasing mechanism does not matter so long as the moveable component is pushed against the door when the door is closed. The location of the biasing mechanism may be chosen in order to minimize wear and tear or prevent debris from entering the biasing mechanism. For example, the biasing mechanism could be located within a housing 14 near the throat of the tong.

In an exemplary embodiment, a cable 32 may be configured to engage and disengage the hydraulic supply from the motor through axial movement of the cable within the bore. The cable may be connected directly to the valve control 60 and the door 18, or may be connected to the valve control 60 and the door 18 through intermediate connections such as rods and pistons. So long as the cable connects directly or indirectly to the valve control 60 and the door 18, it is configured to engage and disengage the hydraulic supply from the motor through axial movement of the cable within the bore within the meaning of this patent document. For example, the moveable component 140 may also include a piston connected to the cable in which the piston is configured to physically contact the door when in the closed position.

In an exemplary embodiment, the door may include a block configured to contact the piston when the door is in the closed position. The block may be an integral part of the door or may be a component that is permanently or semi-permanently secured to the door such as by welding. The addition of a block allows for fine adjustment of the position of contact between the door and the moveable component. The block also allows the door switch to be placed at various angles. The angle of the door switch allows the door switch to be placed on various sizes and shapes of tongs. The block 20 may include a ramp 21 and a divot 25, and the ramp 21 and the divot 25 are shaped to receive the piston 58 (FIG. 4). The piston contacts the ramp 21 at a first end and moves along the ramp to a second end. The piston then moves into the divot 25 after moving up the ramp. The ramp allows the block to contact the piston in a smooth manner, preventing the block from hitting the piston with a blunt impact. A convex or concave shape may also be used in place of the ramp. The piston may include a friction reducer to reduce the friction between the ramp and the piston, for example, a roller or bronze material may be used at the contact point between the block 20 and piston.

In an exemplary embodiment as shown in FIG. 1, the door 18 may be pivotally mounted on the body 19 on a first side of the throat 85 and the moveable component is in operational contact with an end of the door opposite from the first pivot when the door is in the closed position. The contact between the moveable component and the door on the portion of the door opposite from the pivot allows for more precision to disengage the hydraulic supply when the door opens. The movement of the door will be greatest at the furthest distance from the pivot, meaning that it is advantageous to place to the contact point for the moveable component at the point furthest from the pivot, that is at a distal end of the door. In some embodiments, the door may comprise a first door and a second door, and the sleeve 38 may be connected to the second door as is shown in FIG. 8. Reference to a first door in the claims does not mean that there are necessarily two doors. The sleeve may be connected to the first door 18 indirectly by various components. The second door 18 may have a second pivot end 22 mounted on a second pivot on the body on a second side of the throat 85, and the sleeve connected to the second door 18. The door pivots on both ends and the door switch biases the moveable component into contact between the two doors when the doors are in the closed position and the movement of the doors away from each other around their respective pivots caused the door switch to actuate the valve control.

The piston may be substantially axially aligned with a centerline of the radius or substantially perpendicular with the centerline. The term “substantially” in this context means within plus or minus 30 degrees from vertical or perpendicular. This configuration allows the door switch to be placed on tongs with a small footprint or on a body congested with other components. In the case where the moveable component is a cable, the switch end of the cable may be configured to be in operational contact with the distal end of the door when the door is in a closed position. This operational contact may be direct or indirect, such as through intermediate rods and pistons. For example, a piston may be connected to the cable and the piston may contact the distal end of the door when the door is in a closed position. In some embodiments, the door switch may not use a biasing mechanism. For example, the movable component may be connected to a magnet that moves the moveable component to a certain position and then releases.

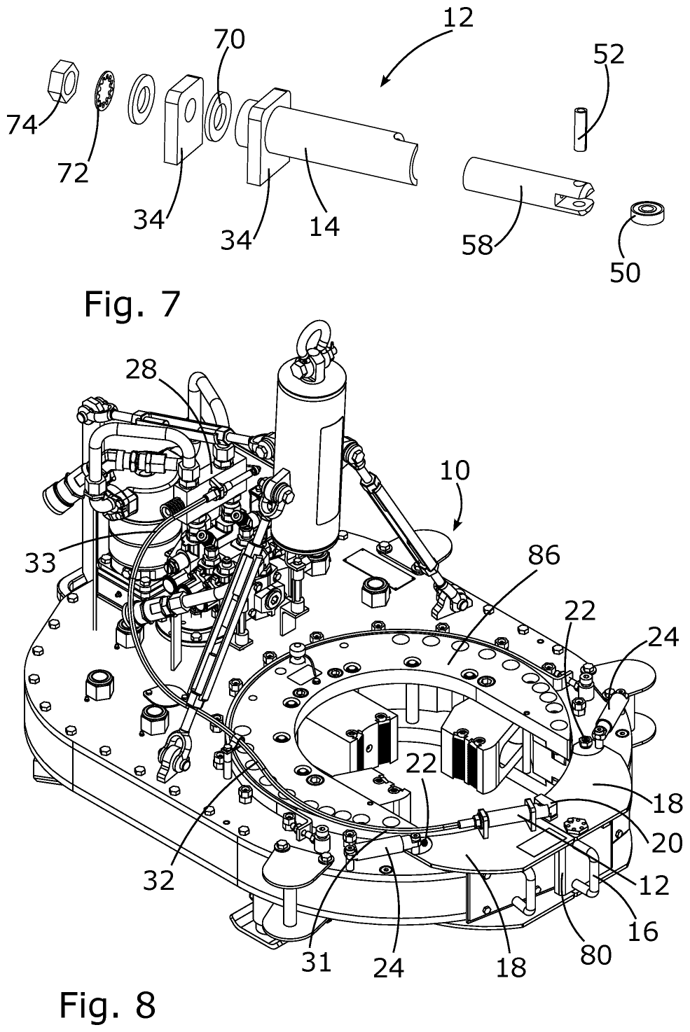

In an exemplary embodiment shown in FIG. 7, a roller 50 is shown on a piston 58. The roller 50 may be secured to the piston 58 by a spring pin 52. The roller may also be secured to the piston by a bolt or rivet. The piston 58 may be secured to a rod 37 (shown in FIG. 12) by a threaded connection, or a welded connection or spring pin type connection. A housing 14 may include a bore large enough to accommodate the piston 58 and allow axial movement of the piston 58 within the housing 14. Alternatively, the piston may be held by opposing keys on opposite sides of the piston, without a housing fully enclosing the piston.

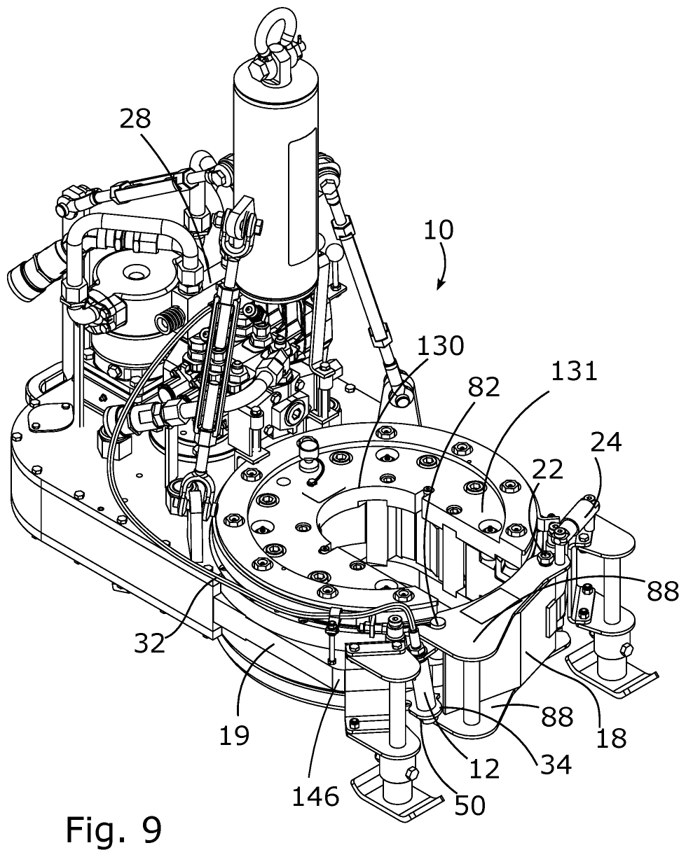

In an exemplary embodiment shown in FIG. 12, the rod 37 may be secured to a cable 32 through a bore in the sleeve end 36. The cable 32 may comprise a switch end 31 (as shown in FIG. 1) connected to the rod 37. The cable 32 may be within a sleeve 38, the sleeve 38 defining a bore. The cable 32 is axially movable within the sleeve 38. The sleeve 38 may be secured to the sleeve end 36. The rod 37 may move axially within the sleeve end 36. Alternatively, the rod may be connected to a piston that is axially moveable by hydraulic fluid within the sleeve. The sleeve end 36 may include threading around its outer circumference or shoulders that act as connection points. Referring to FIG. 7, the sleeve end 36 may be secured within housing 14 and be held in place by nut 74, lock washer 72, washer 70, and tab 34. These components allow the sleeve end 36 axial position to be adjusted so that the piston contacts the block 20 at the optimal position. The sleeve end 36 may also be adjusted by a set screw and key system. The housing tab 34 may include a threaded hole for securing the sleeve end 36 in place or may be a through hole. The housing tab 34 through hole may be large enough to accommodate housing 14 or may be large enough to accommodate the sleeve end 36. Referring to FIGS. 1 and 4, the door switch 12 may be secured to the body 19 by welding housing tab 34 to the body, or by clamping or screwing the door switch 12 to the body 19. The moveable component may run partially along a side 146 of the body. The side 146 being defined as the side perimeter of the body. The side position of the body may be advantageous on some power tongs where the remainder of the body is congested with various components. For example, by having the moveable component and sleeve run along the side of the body avoids the needs to place the sleeve on the top or bottom of body. As shown in FIG. 9, the sleeve and moveable component are placed along the side of the body near the top.

As an alternative to the cable 32, the rod 37 may be connected to a piston (not shown) and fluid may be contained within the sleeve 38. The cable 32 may then be replaced with a hydraulic fluid. The movement through the sleeve would then be transferred by the hydraulic fluid instead of the cable.

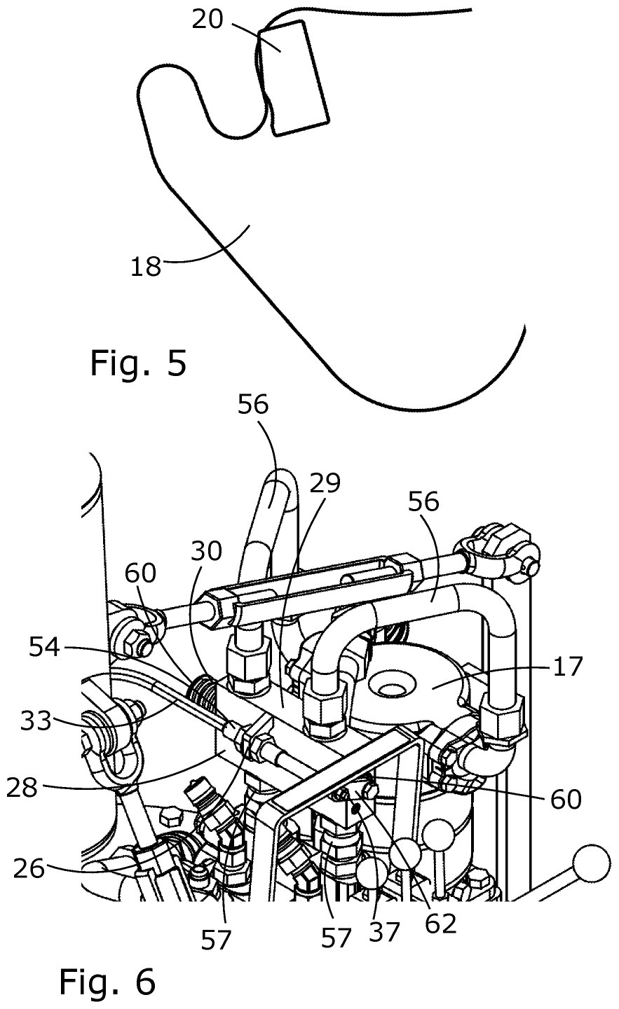

An exemplary embodiment of a door 18 will now be described. Referring to FIG. 1, the door 18 is shown in the closed position. The door 18 covers the opening in the ring gear assembly 86, the opening being known as the throat 85 of the ring gear assembly 86. The door 18 pivots about the door pivot 22. The door pivot 22 may be a connection between the door 18 and the body 19. The door pivot connection may be a bolt, bearing, or pin, or other rotatable fastener. The door pivot 22 may be on a side of the throat 85. The door 18 may comprise a block 20. The block 20 may be secured to the door 18 or form part of the door 18. The block 20 may be located at the end away from the door pivot 22, on the other side of the throat 85 from the pivot 22. The location of the block 20 on the end of the door 18 is also shown in FIG. 5. Referring to FIG. 1, the door 18 may be held closed at least partly by the door assist 24. The door assist 24 may comprise an assist door spring that applies force to assist with closing the door 18. The door may include a handle 16. The tong operator may use the handle 16 to open and close the door. The door 18 may be automated by an actuator to open and close.

An exemplary embodiment of a valve 28 will now be described. Referring to FIGS. 1 and 6, the valve 28 is shown. The valve 28 may comprise a valve housing 29. The valve housing 29 may include a bore that contains a valve control 60 therein. The valve control 60 may be in the shape of a rod or shaft, with varying diameters throughout. The valve control 60 may be connected to a biasing mechanism 30. The valve control 60 may move between a neutral or shifted position.

The valve control 60 may be held in the neutral position by a biasing mechanism 30 that is secured to the valve control 60. The biasing mechanism may contact other components of the door switch 12 to apply a bias force to the moveable component. In the neutral position, hydraulic fluid flow cannot enter motor 17. In the neutral position, the valve 28 may receive a hydraulic supply of fluid from a first hydraulic source tube 57 and send the fluid flow back through a second hydraulic source tube 57, preventing the flow from entering tubes 56 and reaching the motor 17. In the neutral position, the motor 17 cannot receive flow and the ring gear assembly 86 cannot rotate, protecting the user from a rotating component when the door is open.

In contrast, the valve control 60 may be in a shifted position. In the shifted position, the hydraulic supply of fluid enters the motor 17 through a first tube 56 from a first hydraulic source tube 57 after traversing through the valve 28. The fluid then flows through the motor 17 and exits the motor 17 through a second tube 56, through the valve 28, and through a second hydraulic source tube 57. In the shifted position of the valve control 60, the motor 17 can operate the ring gear assembly 86 and cause rotation of the ring gear assembly 86.

An example of the valve control's 60 operational connection to the cable 32 will now be described. Referring to FIG. 6, sleeve valve end 54 may be secured to the valve 28 by valve secure tab 26. The sleeve valve end 54 may alternatively be welded to the valve 28. Sleeve valve end 54 may include threads on its outer diameter that secure sleeve valve end 54 through valve secure tab 26 by nuts on either side of the valve secure tab 26. The nuts allow the position of the secure valve end 54 to be adjusted axially. The sleeve valve end 54 may have the same configuration as described with respect to the sleeve end 36. Specifically, sleeve valve end 54 may comprise a rod 37 therethrough. The rod 37 may move axially within the sleeve valve end 54. Rod 37 may be secured to link 62 by nuts threaded on the end of rod 37. Link 62 may be secured to valve control 60 by a bolt on the end of the valve control 60 or by a welded or interference connection.

In an exemplary embodiment, a sleeve 38 may be secured to the sleeve valve end 54. The cable 32 may be included in the bore of the sleeve 38. The cable 32 may comprise a valve end 33 (as shown in FIG. 1) connected to the rod 37 that is connected to the link 62. The link 62 may be connected to the valve control 60. In this way, the valve end 33 is operationally connected to the valve control 60. The valve control 60 may optionally directly connected to the rod, by adding an angle to the rod end. The cable 32 may extend between the valve end 33 and switch end 31 (as shown in FIG. 1).

The moveable component 140 comprises any components that operationally connect the door 18 to the valve control 60. For example, the moveable component 140 may comprise the roller 50, the piston 58, first rod 37 in the sleeve end 36, the cable 32, the second rod 37 in the sleeve valve end 54, and the link 62. Axial movement of the movable component 140 causes axial movement of the valve control 60.

In an exemplary embodiment shown in FIG. 1, the biasing mechanism 30 applies a force to the movable component 140. This force holds the moveable component 140 in a neutral position. For example, the biasing force may be applied to the movable component 140 through the valve control 60. Referring to FIG. 6, the biasing mechanism 30 holds the link 62 (shown in FIG. 6) against or near the valve housing 29. This position of the link 62 against or near the valve 29 is an example of the neutral position of the valve control 60. The link 62 may also be positioned farther out in the neutral position. In this position, the piston 58 is positioned in an axially extended position. The piston 58 may be positioned anywhere that allows contact with the door 18 in the extended position. The biasing mechanism 30 holds the piston 58 in this extended position until the piston 58 is acted upon by the door 18.

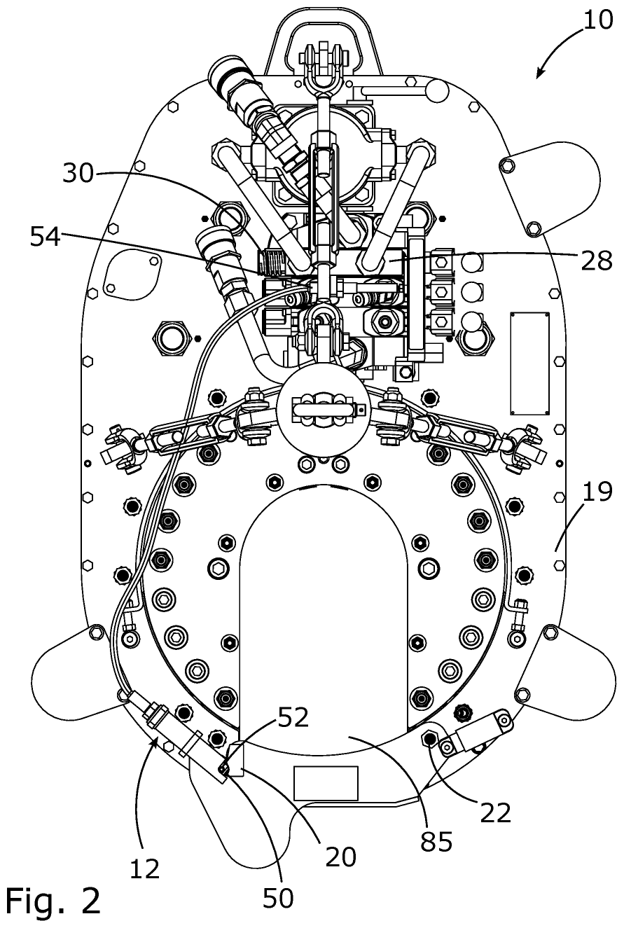

In an exemplary embodiment shown in FIGS. 1 and 2, the door 18 is shown in the closed position. In this position, the door 18 closes the throat 85. When the door 18 is closed, the moveable component 140 is contacted by the door 18 and the moveable component 140 shifts axially. The valve control 60 is connected to the moveable component 140. As a result, the valve control 60 is then also moved to the shifted position, and the hydraulic supply is allowed to enter the motor 17. The moveable component 140 may be shifted by the block 20. For example, the block 20 may axially shift the roller 50. This may then move the piston 58 axially inwards. The movement may be transferred through the first rod 37 in the sleeve end 36, through the cable 32, to the second rod 37 in the sleeve valve end 54, and to link 62. These connections are an exemplary embodiment of the moveable component 140. The movement of the moveable component 140 then moves the valve control 60. The shift of the valve control 60 may compress the biasing mechanism 30. In this shifted position, the compression on the biasing mechanism 30 causes a biasing force between the movable component 140 and the door 18. The door 18 or block 20 stops the piston 58 from moving extending outwards and the biasing mechanism 30 from returning the valve control 60 to the neutral position. The door or block may be in any appropriate shape to act on the moveable connection.

By way of further exemplary embodiment of the closed position, in the closed position, the switch end 31 of the cable 32 may be in operational contact with the distal end of the door 18. The load applied to the roller 50 by the block 20 may also be applied to the valve control 60 and against biasing mechanism 30. In the closed position, hydraulic fluid may flow through tubes 56 into the motor 17 to operate the motor 17. In this position, the motor 17 allows the ring gear assembly 86 to operate. Therefore, when the door 18 is closed, the motor 17 and ring gear assembly 86 can operate, protecting the user from the moving components.

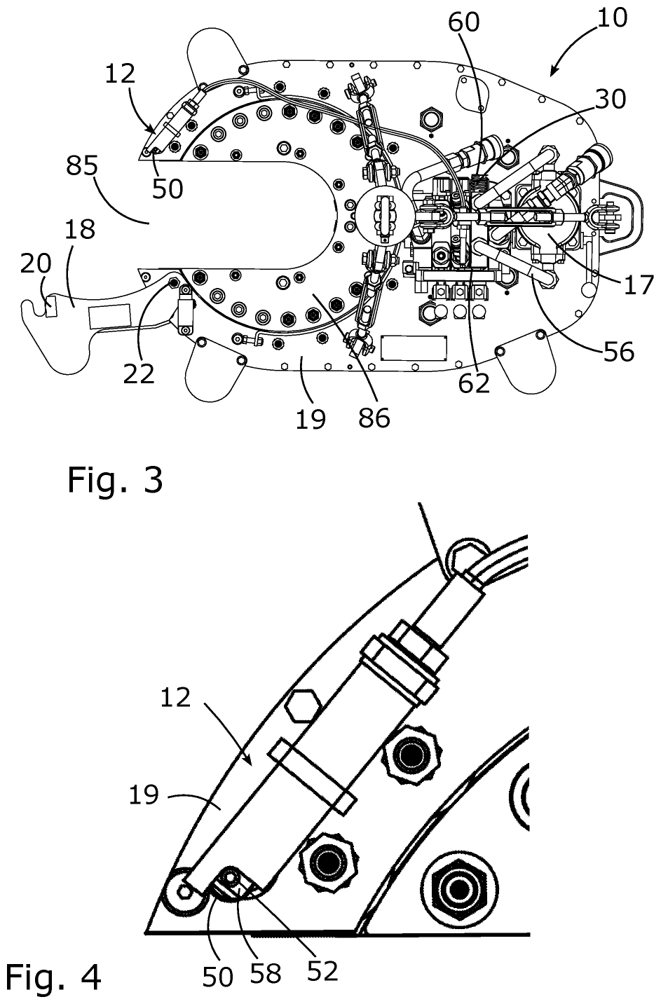

An exemplary embodiment of the door switch 12 operation when the door 18 is in the open position will now be described. Referring to FIGS. 3, 4, and 5 the door 18 is shown in the fully opened position. When the door 18 is opened, even slightly, the moveable connection 140 shifts and begins to disengage from the door 18. In an exemplary embodiment, when the door is opened, the roller 50 and piston 58 move outwards axially from within the housing 14. The roller 50 may move outwards because the block 20 disengages from the roller 50 and piston 58, allowing the piston 58 to move axially outwards. The piston 58 moves outwards because of the force from the biasing mechanism 30 applied through the movable connection 140. As the piston 58 moves outwards axially, the valve control 60 moves into a neutral position by force of the biasing mechanism 30 on the valve control 60. In the neutral position, hydraulic fluid does not flow to the motor 17 through tubes 56. In the neutral position, the motor 17 cannot operate to rotate the ring gear assembly 86. In this way, the tong operator is protected from the rotation of the ring gear assembly 86 when the door 18 is opened. The moveable connection may also transfer lateral movement, for example, a lever type of connection through its components.

One or exemplary embodiments of the door switch may have certain advantages. For example, the position of the block 20 and door switch 12 on the far side of the door 18 away from the pivot 22 allows for high sensitivity of the device to any angular movement of the door. The door block 20 is at nearly the farthest point from the pivot 22 location. Thereby, even a minor angular movement of the door 18 translates into a large circumferential movement of the door block 20. This provides the door switch 12 with a high sensitivity to the door 18 opening, even slightly. This provides the tong operator with immediate protection from the rotation of ring gear assembly 86 if the door 18 is even slightly opened.

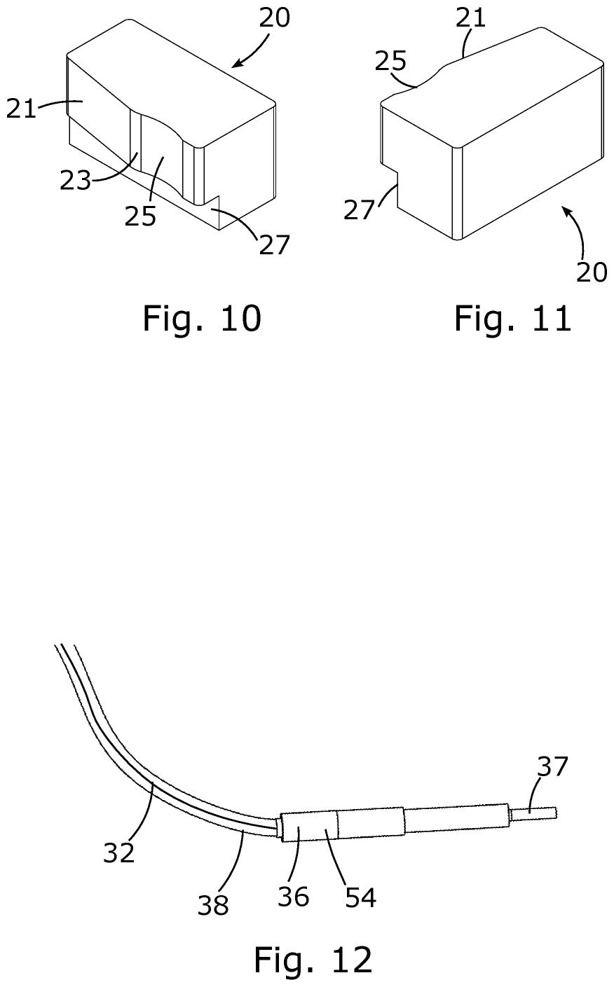

An exemplary embodiment of the block 20 will now be described. Referring to FIGS. 10 and 11, the block 20 is shown. The block 20 may be secured to or form part of the door 18 and provides a rolling surface for the roller 50. When the door 18 is nearly fully closed, the roller 50 initially engages with the ramp portion 21 of the block 20. As the door 18 continues to close, the roller 50 moves up the ramp towards radius 23. The ramp 21 engagement with the roller 50 shifts the roller 50 and piston 58 axially inwards within the housing 14. As the door continues to close, the roller 50 moves into a divot 25. The divot 25 holds the roller 50 and piston 58 in the axially shifted position within the housing 14. The divot 25 also assists with keeping the door 18 in a closed and locked position by the force of biasing mechanism 30. The valve control 60 only allows fluid to flow to the motor 17 when the roller 50 is in the divot 25 position. In an embodiment, the block may include a cut out 27. Alternative configurations of the block 20 that move the moveable component axially may also be used. The door 18 may be in a form of operational contact with the piston 58 that causes axial movement of the piston 58.

In an exemplary embodiment, on even a slight opening of the door 18, the roller 50 moves out of the divot 25, and onto ramp 21. In this position, the force of the biasing mechanism 30 continues to push the door 18 open and the roller 50 further down the ramp 21. As the roller 50 moves down the ramp 21, the biasing mechanism 30 pushes the roller 50 and piston 58 axially outwards from within the housing 14. As a result, the valve control 60 moves back into the neutral position by force of the biasing mechanism 30. In the neutral position, the fluid cannot flow to motor 17 through tubes 56 and the ring gear assembly 86 cannot rotate.

An exemplary double door embodiment will now be described. Referring to FIG. 8, a plurality of doors 18, namely, a first and a second door 18, are shown. The doors 18 may each include pivot connections 22 on opposite sides of a throat 85. The door switch 12 may be secured to one of the plurality of doors 18, and the block 20 may be secured to the other of the plurality of doors. The switch 12 and block 20 may be secured on the door 18 at a location away from the pivot 22 at the distal end. There may be a latch 80 included between the doors to keep the doors 18 connected when in the closed position.

Another exemplary embodiment of the door switch 12 will now be described. Referring to FIG. 9, the door switch 12 is shown in a substantially axially vertical orientation. The door switch 12 may be secured to the body 19 or other component that places the moveable component in a position of operational engagement with the door. For example, the roller 50, and thereby the piston 58, may engage with a portion of the door plate 88 when the door 18 is in the closed position. At the location of roller engagement, door plate 88 may have the same ramp 21 and divot 25 as is disclosed on the block 20, or other shape that causes axial movement of the moveable component. In an embodiment, the door switch 12 may be positioned anywhere within 30 degrees of vertical or perpendicular axial alignment with the centerline of the tong throat radius 130. This axial alignment position of the door switch 12 allows the door switch 12 to be placed in compact tongs 12. Smaller and more compact tongs are advantageous on a drilling rig as they are lighter and more easily maneuverable.

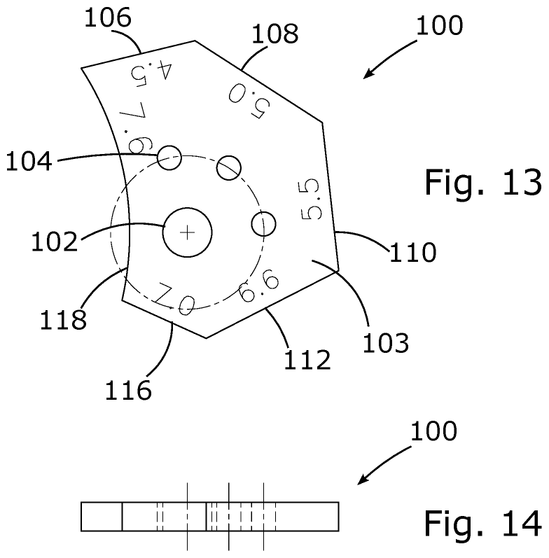

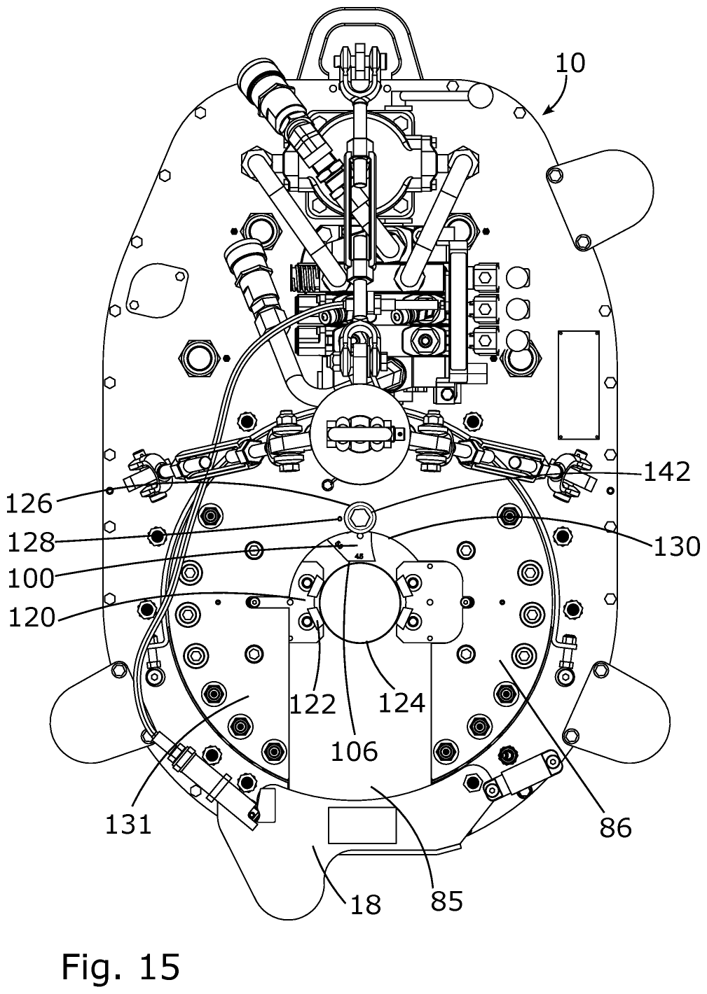

An exemplary embodiment of a tab 100 is described. Referring to FIGS. 13 and 14, a tab 100 is shown. The tab 100 is used to center a tubular within the power tong during operation. The tab has a body 103 having a perimeter and may have a through hole 102 extending through the body within the perimeter. The tab 100 may be made of non-compressible material such as steel or bronze. Other non-compressible materials may be used so long as they are sturdy enough to hold the tubulars in position during placement of the tubulars within the power tongs. The tab 100 may also be made of a rubber or similar compressible material, provided the durability allows and the material is strong enough for correct positioning of the tubular. The body has a plurality of edges on the perimeter, each of the plurality of edges define a smallest distance from a center of the through hole to the respective edge. Each of the smallest distances of each of the plurality of edges may be different in size. The different smallest distance from the center of the through hole each allow for the placement of different sizes of tubulars. The through hole 102 may be used to receive a bolt or other fastener to allow for centering rotation for the tab. The through hole 102 also allows for connecting to the ring gear assembly 86 such as by bolt 126 (shown in FIG. 15). Other types of fasteners may be used for the connection, for example, a magnet, an interference fit pin, or a clamp. The clamp may be a C-clamp.

In an exemplary embodiment, the plurality of edges may have any of a number of shapes, and for example, may be straight or curved. One or more edges may be curved to match the radius of the tubular. Alternatively, the edge radius may be larger or smaller than the radius of the tubular. For example, the edge radius may be 0.0625 to 0.375 inches larger or smaller than the tubular radius. This is to account for tolerances in tubular radius machining and to ensure the tubular contacts the edge at the midpoint of the edge. Alternatively, the edge may be shaped to allow for contact on points other than the midpoint. For example, the edge may be shaped to allow two or more contact points with the pipe. Further, the edge may be shaped to contact on an end or midpoint of the edge. Only some of the edges may be curved. Straight edges reduce costs and prevent damage to the tab. The straight edges provide more strength at the corners. Curved edges provide a sharper corner, reducing the strength of the corner. In the embodiment shown in FIG. 13 an edge of the plurality of edges is curved to match a radius of a throat when placed in the power tong. This curved edge is designed to match the largest size of tubular, which corresponds to the edge with the smallest distance from a center of the through hole to the edge.

In an exemplary embodiment, the tab 100 may optionally include a lock hole 104. The lock hole 104 may hold the tab 100 in its rotated position by bolt 128. Bolt 128 and 126 may each pass through holes in a top or bottom plate 131 in the ring gear assembly 86. The body 103 may have a perimeter comprised of edges 106, 108, 110, 112, 116, 118. The plurality of edges 106, 108, 110, 112, 116, 118 each defining a smallest distance from a center of the through hole 102 to the respective edge. The body 103 may have any number of edges. Each of the smallest distances of each of the plurality of edges 106, 108, 110, 112, 116, 118 being different in size. The tab 100 may be shaped to have a first smallest distance from a first edge 118 to the through hole 102 center. The tab 100 may be shaped to have a second smallest distance from a second edge 116 to the through hole 102 center. The tab 100 may be shaped to have a third smallest distance from a third edge 112 to the through hole 102 center. The tab 100 may be shaped to have a fourth smallest distance from a fourth edge 110 to the through hole 102 center. The tab 100 may be shaped to have a fifth smallest distance from a fifth edge 108 to the through hole center 102. The tab 100 may be shaped to have a sixth smallest distance from a sixth edge 106 to the through hole center 102. An edge 118 may be shaped to match or substantially match the radius 130 of the throat 85 when the bolt 126 is in the through hole 102 and to not touch the tubular 124 when the an edge 118 is selected. The tubular 124 may also be a pipe 124 or other component used within a well string. The tab 100 may have any number of edges for any number of tubular sizes. For example, an edge 106 may be used with a 4.5-inch diameter tubular. The edge 108 may be used with a 5-inch diameter tubular. The edge 110 may be used with a 5.5-inch diameter tubular. The edge 112 may be used with a 6.6-inch diameter tubular. The edge 116 may be used with a 7.0-inch diameter tubular. The edge 118 may be used with a 7.6-inch diameter tubular. The edges may be shaped to accommodate any size of tubular.

An exemplary embodiment of the tab 100 in the tong 10 will now be described. Referring to FIG. 15, the tab 100 is shown secured to a plate 131 of the ring gear assembly 86. The ring gear assembly 86 may include a plurality of jaws 120. The plurality of jaws 120 may include a plurality of teeth 122. The ring gear assembly 86 may comprise a tab 100. The tab 100 may be secured in place by a bolt 126 connected to the ring gear assembly 86 through a fastener-receiving hole 142. The bolt 126 may include a nut for connection or other fastener, such as a pin. The tab 100 may extrude inwardly from a radius 130 of the throat. The tab 100 may be locked from rotation by a bolt 128 through lock hole 104. Alternatively, the tab 100 may be held from rotation by only bolt 126, with adequate clamping force on bolt 126 to prevent rotation of tab 100. Alternatively, the tab may be held from rotation by a magnet or clamp.

The operation of the tab 100 is a method for centering a tubular 124 within a tong 10. In an exemplary embodiment shown in FIG. 15, the tubular 124 is shown within the tong 10. For example, the user may insert the tubular 124 into the tong 10 through throat 85 when the door 18 is open. The user may push the tubular 124 into the tong 10 by moving the tong 10 around the tubular 124 until the tubular 124 contacts the selected edge 106 of the tab 100. The tab 100 may be set to other edges 106, 108, 110, 112, 116, 118 by the user as required based on the circumference or outer diameter of the tubular 124 for centering. The tab 100 may rotate about through hole 102 for selecting the edge. Through the contact between a selected edge 106 and the tubular 124, tab 100 centers the tubular 124 in the ring gear assembly 86 as required for the bite. FIG. 15 shows the tubular 124 in a required centered position. The user may then close the door 18. The jaws 120 may then move inwardly towards the tubular 124 causing the teeth 122 to engage with or bite on the tubular 124. In FIG. 15, the jaws 120 are shown moved inwardly and in the biting or closed position, and the teeth 122 are in contact with the tubular 124. The plurality of teeth 124 are sized to contact a diameter of tubular when in the closed position. The selected tab edge is shaped to be on the same diameter. The selected edge may also be positioned slightly outwardly from the outer diameter that is defined by the tubular when it is in position within the jaws to account for various pipe, jaw, and teeth tolerances. For example, the selected edge of the tab may be 0.75 inches radially outwards from the diameter defined by the tubular when it is in position within the jaws. The jaws 120 are considered to be in the open, non-biting position biting when they are moved outwards away from the tubular 124.

If an alternate size of tubular 124 is required or used, the user may swap the jaw size 120 or the teeth 122 size to substantially match the diameter of the new tubular. Tubulars 124 generally come in standard sizes, with various allowable tolerances, as is known in industry. In order to ensure correct positioning of the tubular 124 for the bite using tab 100, the user may rotate tab 100 by loosening bolt 126 or other appropriate fastener 126. The user then rotates tab 100 about through hole 102 into the required position. Once in the required rotated position, the user may tighten bolt 126, or other appropriate fastener 126, securing the tab 100 position through the clamping force on the tab 100. The new tab position has an edge 110, 112, 116, 118, 106, or 108 that is on a diameter defined by the teeth in their biting position or is located within 0.75 inches radially outwards of the diameter.

In an exemplary embodiment of the tab operation, the tab 100 may be used to center a tubular within the power tong. At least one of the plurality of edges of the tab 100 is aligned to match a circumference defined by a closed position of the teeth 122 of the power tong. The tab is secured with a fastener through the through hole of the tab and the fastener-receiving hole 142 of the body of the power tong. In repeated use of the tab, the user may loosen the fastener, rotate the tab to align a different one of the at least one of the plurality of edges with the circumference defined by the position of the teeth in the closed position and tighten the fastener. This operation may be done at various times while the tongs are being used. The tab may also be used for only one size of pipe for one well site, or may be used for multiple different sizes of pipe for the well site. A power tong may be designed to operate with the tab or may be retrofitted by drilling a fastener-receiving hole on the ring gear assembly of the power tong.

Immaterial modifications may be made to the embodiments described here without departing from what is covered by the claims.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A door switch for a power tong, the power tong having a ring gear assembly having a throat, the ring gear assembly being driven by a motor having a hydraulic supply and a door pivotally mounted on a body to open and close the throat, the door switch comprising:
a sleeve defining a bore;
a moveable component within the bore, the moveable component being in operational contact with the door and a valve control of a valve connected to the hydraulic supply; and
a biasing mechanism acting to bias the moveable component into contact with the door when the door is in a closed position, the biasing mechanism biasing the moveable component to move axially when the door is at least partially open to cause the valve to disengage the hydraulic supply from the motor, the moveable component disengaging from the door when the door is at least partially open.

2. The door switch of claim 1, wherein the moveable component comprises a cable within the bore, wherein the cable is configured to engage and disengage the hydraulic supply from the motor through axial movement of the cable within the bore.

3. The door switch of claim 2, wherein the moveable component further comprises a piston connected to the cable, the piston being configured to contact the door when the door is in the closed position.

4. The door switch of claim 3, wherein the biasing mechanism comprises a spring configured to bias the piston against the door when the door is in the closed position.

5. The door switch of claim 3, wherein the door comprises a block configured to contact the piston when the door is in the closed position.

6. The door switch of claim 5, wherein the block comprises a ramp and a divot, and the ramp and the divot are shaped to receive the piston.

7. The door switch of claim 1, wherein the door is pivotally mounted on a body on a first side of the throat and the moveable component is in operational contact with an end of the door opposite from the first pivot when the door is in the closed position.

8. The door switch of claim 3, wherein the movable component extends partially along a side of the body.

9. The door switch of claim 1, wherein the door comprises a first door and a second door, and the sleeve is connected to the second door and the moveable component is in operational contact with the first door.

10. The door switch of claim 1 in operation on a power tong.

11. A power tong, comprising:
a ring gear assembly having a throat, the ring gear assembly being driven by a motor having a hydraulic supply;
a first door having a pivot end mounted on a first pivot on a body on a first side of the throat, the first door having a distal end that opens and closes the throat with movement of the first door around the first pivot; and
a door switch, comprising a sleeve defining a sleeve bore and a cable axially moveable within the sleeve, the cable having a valve end and a door end, the valve end of the cable being in operational connection with a valve control operable to disconnect the hydraulic supply from the motor, and the switch end of the cable being configured to be in operational contact with the distal end of the first door when the first door is in a closed position.

12. The power tong of claim 11, further comprising a piston connected to the cable and the piston contacting the distal end of the first door when the first door is in a closed position.

13. The power tong of claim 12, further comprising a biasing mechanism to bias the piston into contact with the distal end of the first door when the first door is in a closed position.

14. The power tong of claim 13, wherein the biasing mechanism comprises a spring.

15. The power tong of claim 12, wherein the first door further comprises a block at the distal end of the door configured to contact the piston when the first door is in the closed position.

16. The power tong of claim 15, wherein the block comprises a ramp and a divot, and the ramp and the divot are shaped to receive the piston.

17. The power tong of claim 11, a second door having a second pivot end mounted on a second pivot on the body on a second side of the throat, and the sleeve connected to the second door.

18. A tab for a power tong, the tab comprising a body having a perimeter and having a through hole extending through the body within the perimeter, the body made of a non-compressible material, the body having a plurality of edges on the perimeter, each of the plurality of edges defining a smallest distance from a center of the through hole to the respective edge, and each of the smallest distances of each of the plurality of edges being different in size.

19. The tab of claim 18 in which an edge of the plurality of edges is curved to match a radius of a throat when placed in the power tong.

20. A method of centering a tubular within a power tong, the power tong having a ring gear assembly having a throat, the ring gear assembly including teeth to engage a tubular and the ring gear assembly including a fastener-receiving hole, the ring gear assembly being driven by a motor having a hydraulic supply and a first door pivotally mounted on a body to open and close the throat, the method comprising:
aligning at least one of the plurality of edges of the tab of claim 18 to match a circumference defined by a closed position of the teeth; and
securing the tab with a fastener through the through hole of the tab and the fastener-receiving hole.

21. The method of claim 20, further comprising:
loosening the fastener;
rotating the tab to align a different one of the at least one of the plurality of edges with the circumference defined by the position of the teeth in the closed position; and
tightening the fastener.
